(19) United States
(12) Patent Application Publication
(10) Pub. No.: US 2022/0149685 A1
(43) Pub. Date: May 12, 2022

(54) AUTOMOTIVE AUXILIARY UNIT WITH AN ELECTRIC MOTOR

(71) Applicant: PIERBURG PUMP TECHNOLOGY GMBH, NEUSS (DE)

(72) Inventors: STEFFEN SCHNURR, ESSEN (DE); NABIL SALIM AL-HASAN, KORSCHENBROICH (DE); STANISLAUS RUSS, MOENCHENGLADBACH (DE); TOBIAS GRUENE, ARNSBERG (DE); PETRA HAGEN, DUISBURG (DE); MARCEL PIOTROWSKI, KORSCHENBROICH (DE); SEBASTIAN IRMER, ESSEN (DE)

(73) Assignee: PIERBURG PUMP TECHNOLOGY GMBH, NEUSS (DE)

(21) Appl. No.: 17/601,923

(22) PCT Filed: Apr. 10, 2019
(86) PCT No.: PCT/EP2019/059075

§ 371 Date: Oct. 7, 2021

(51) Int. Cl. H02K 1/28; H02K 7/00; F04B 37/14; F04B 35/04

(52) U.S. Cl. CPC H02K 1/28; F04B 35/04; F04B 37/14; H02K 7/003

(57) ABSTRACT

An automotive auxiliary unit with an electric motor. The automotive auxiliary unit includes a motor stator, a rotatable metallic rotor shaft which defines a rotor fixation section, and a motor rotor which is co-rotatably fixable to the rotatable metallic rotor shaft via pressing at the rotor fixation section. The rotor fixation section has material bulgings at a shaft surface of the rotatable metallic rotor shaft. The material bulgings at the shaft surface of the rotatable metallic rotor shaft are provided via a laser engraving.

### CROSS REFERENCE TO PRIOR APPLICATIONS

This application is a U.S. National Phase application under 35 U.S.C. § 371 of International Application No. PCT/EP2019/059075, filed on Apr. 10, 2019. The International Application was published in English on Oct. 15, 2020 as WO 2020/207576 A1 under PCT Article 21(2).

### FIELD

The present invention is directed to an automotive auxiliary unit, for example, to an automotive vacuum pump for generating a vacuum.

### BACKGROUND

Such auxiliary units in automobiles can, for example, be vane cell vacuum pumps for supplying other devices, such as brake boosters, with an absolute pressure of about 100 mbar. Conventional automotive auxiliary units are driven mechanically by an internal combustion engine of a motor vehicle. In order to be independent of the rotational speed of the internal combustion engine, electric auxiliary units such as, for example, vacuum pumps driven electrically by an electric motor are becoming increasingly common. The electric motor is provided with a rotor shaft and a separate motor rotor fixed to the shaft.

DE 10 2005 046 285 A1 and DE 10 2016 216 476 A1 describe two different arrangements for mounting the motor rotor positively with the rotor shaft. The rotor shaft in DE 10 2005 046 285 A1 is provided with a gear shaped cross section, whereas the rotor shaft in DE 10 2016 216 476 A1 has a polygonal cross section. The motor rotor is in either case provided with a corresponding inner profile in order to be fixed co-rotatably to the shaft to thereby transfer relatively high torques. The motor rotor in DE 2017 011 969 A1 is furthermore fixed to the rotor shaft using a casting process. DE 10 2017 115 229 A1 also describes a fixation arrangement which includes a bushing for mounting the motor rotor at the rotor shaft.

Prior art arrangements require a considerable assembly effort or additional components.

### SUMMARY

An aspect of the present invention is to provide an automotive auxiliary unit with a reliable and cost-effective fixation arrangement for mounting the motor rotor at the rotor shaft so that a high torque transmission is possible.

In an embodiment, the present invention provides an automotive auxiliary unit with an electric motor. The automotive auxiliary unit includes a motor stator, a rotatable metallic rotor shaft which defines a rotor fixation section, and a motor rotor which is co-rotatably fixable to the rotatable metallic rotor shaft via pressing at the rotor fixation section. The rotor fixation section comprises material bulgings at a shaft surface of the rotatable metallic rotor shaft. The material bulgings at the shaft surface of the rotatable metallic rotor shaft are provided via a laser engraving.

### BRIEF DESCRIPTION OF THE DRAWINGS

The present invention is described in greater detail below on the basis of embodiments and of the drawings in which:

FIG. 1 shows a schematic arrangement of the automotive auxiliary unit with an electric motor;

FIG. 2 shows a cross section of the electric motor of FIG. 1;

FIG. 3 shows a section of the cross section of the rotor shaft of the electric motor of FIG. 2;

FIG. 4 shows a section of an alternative embodiment of the rotor shaft of the electric motor in top view; and

FIG. 5 shows a side view of a part of the rotor shaft of FIG. 2.

### DETAILED DESCRIPTION

The automotive auxiliary unit according to the present invention is provided with a motor stator. The motor stator is housed in a motor housing that separates the auxiliary unit from the environment. The motor stator is arranged coaxially to a motor rotor rotation axis and can be provided with a predetermined number of permanent magnets or with an electromagnetic arrangement. The motor stator is furthermore separated by an air gap from a motor rotor that is, for example, arranged radially inside the motor stator.

The automotive auxiliary unit according to the present invention is also provided with a rotatable metallic rotor shaft. The rotor shaft is provided with material bulgings at the cylindric shaft surface, thereby creating a local shaft surface roughness. The shaft surface area that is provided with bulgings defines a rotor fixation section, the uneven surface serving as a mechanical connecting means between the shaft surface and the motor rotor.

The motor rotor is co-rotatably fixed to the rotor shaft by pressing at the rotor fixation section. The term “pressing” here means that the sheet metal pack is provided with an undersize with respect to the rotor shaft. A microscopic form-fitting connection between the rotor shaft and the motor rotor is realized as a result of the pressing. This connection provides a high-torque transmission capability of the automotive auxiliary unit, as is required, for example, in automotive displacement pumps.

The present invention provides that a laser textured shaft surface is created in order to improve and increase the friction properties between the motor rotor and the rotor shaft so as to create a strong and solid fixation between the two rotor components. A laser beam that can create shaft surface temperatures of more than 1600° C. is thereby used to generate the material bulgings on the shaft surface. The high surface temperatures result in a local melting of the shaft surface material. A portion of the molten shaft surface material re-solidifies after removing the laser beam so that lateral bulges and micro formations are generated. These effects change the shaft surface topology and generate a plurality of local groove-like or indentation-like recesses and re-solidified material accumulations at the shaft surface. The specific shaft surface structure depends on the nature of the laser type used and the working method. The laser can, for example, generate single pulse laser radiation or high-power continuous wave laser radiation.

While the present invention provides an automotive auxiliary unit with a reliable and cost-effective fixation arrangement for mounting the motor rotor at the rotor shaft so that high torque transmission is possible, the bulging generation procedure is speeded up due to the elimination of setup times. Tool wear parts no longer exist, thereby reducing costs. The quality of the generated bulgings is better in that the progressing wear of tool parts is avoided. Quality control is also automatable.

In an embodiment of the present invention, a minimum height of the material bulgings of 15 μm is provided in order to provide a sufficient torque transfer capability between the motor rotor and the rotor shaft. This is needed for transmitting relatively high torques which is typical for displacement pumps.

The motor rotor can, for example, be defined by a sheet metal pack that is a stack of punched ferromagnetic metal sheets. The individual metals sheets are axially joined together to a single rotor body. The metal sheets can, for example, be provided with pin-like surface elevations and corresponding indentations on the back side of each metal sheet, the pin-like surface elevations of one metal sheet being pressed into the indentations of the adjacent metal sheet, thereby creating a mechanical connection between the sheets. Other joining techniques to join the metal sheets are laser welding or adhesive techniques. The resulting sheet metal pack is defined by a plurality of radial recesses that extend axially through the stack, to thereby define a plurality of magnetic poles.

The shaft surface can, for example, be completely hardened so that the shaft surface is protected against abrasive wear. The more flexible shaft center remains elastic so that high shear stresses caused by torsional torque can be transmitted which is necessary for displacement pump applications.

The rotor shaft can, for example, be provided with at least three continuous material bulgings at the shaft surface so as to provide a good fixation between the motor rotor and the rotor shaft. A continuous laser beam is guided along the shaft surface, thereby melting material and displacing it laterally to generate continuous bulgings. The resulting re-solidified material trace is similar to a mountain chain, is coherent, and radially protrudes from the shaft surface. The material bulgings can, for example, be designed as lines. The material bulgings do not, however, necessarily define a strictly straight line, but could define a curved line or a helix.

An alternative embodiment of the present invention provides ring-like material bulgings. The shaft surface is provided with a plurality of circular material throw-ups arranged along a line, the number of lines being, for example, at least three. In contrast to continuous material bulgings, this type of surface topology with individual and separate material throw-ups can be generated via pulsed laser radiation generating recesses in the center of the ring-like bulges. The structural properties of the shaft surface, such as the bulging height, diameter, and hardness, depend on the laser type, the laser power, the radiation duration, and the process gas.

The continuous and longitudinal material bulgings can, for example, be orientated approximately axially. Regardless of the shape of the bulges, continuous or ring-like, the axial orientation of the bulgings can be provided simply by pivoting the laser device to generate a line at the shaft surface or by axially moving the shaft while the laser device is stationary and focused to the shaft surface.

The automotive auxiliary unit can, for example, be provided with at least one electromagnetic coil wire. The coil wire is wound through the radial grooves of the sheet metal pack to define at least two electromagnetic coils.

In an embodiment of the present invention, the motor stator can, for example, comprise at least one permanent magnet. The total torque performance of the auxiliary unit correlates with the number of the permanent magnets within the electric motor.

Further advantages of the present invention will become evident via the following detailed description of embodiments of the present invention in combination with the enclosed drawings.

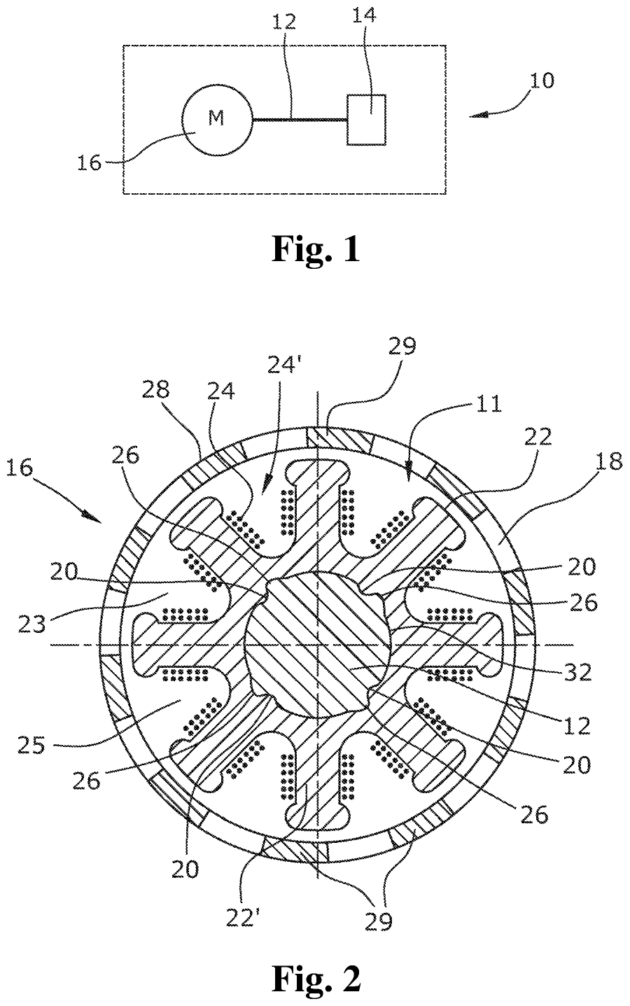

As FIG. 1 shows, the described automotive auxiliary unit 10 according to the present invention comprises an electric motor 16 that drives a pump rotor 14. The pump rotor 14 which can, for example, be a part of a displacement pump, such as a vane cell pump, pumps air in order to generate vacuum. The mechanical connection between the electric motor 16 and the pump rotor 14 is provided via a rotor shaft 12. The electric motor 16 comprises a motor stator 18, a motor rotor 11, and the rotor shaft 12.

The motor stator 18 is arranged in a motor housing (which is not shown in the drawings) and comprises ten permanent magnetic poles 29. Because the motor stator 18, as the stationary part of the electric motor 16, is static and is fixed to the motor housing, the electric motor 16 of the present invention is designed and operated as a so-called internal rotor motor.

The motor rotor 11 comprises a sheet metal pack 22 consisting of numerous identical ferromagnetic metal sheets 22′. Each ferromagnetic metal sheet 22′ is produced by punching so as to define a plurality of radial recesses 25. The ferromagnetic metal sheets 22′ are then piled and joined axially to define the laminated sheet metal pack 22. The radial recesses 25 of the ferromagnetic metal sheets 22′ are arranged during the piling and joining procedure so that the entirety of radial recesses 25 define axial notches 23 throughout the sheet metal pack 22, thereby defining rotor pole heads.

The motor rotor 11 is provided with at least one coil wire 24 defining eight electromagnetic rotor coils 24′ that can be electrically energized so as to generate electromagnetic fields. These electromagnetic fields interact with the permanent magnets 28 of the motor stator 18 and thereby create and maintain a rotation of the motor rotor 11. The coil wire 24 is part of the motor rotor 11.

The motor rotor 11 is rotatably fixed to the rotor shaft 12 by pressing at a rotor fixation section 34. The rotor fixation section 34 describes a section on the shaft surface 32 that defines the axial position of the sheet metal pack 22. In order to provide a sufficient pressing, a height 30 of the material bulgings 26 or 26′ with respect to the shaft surface 32 of 15-30 μm is provided.

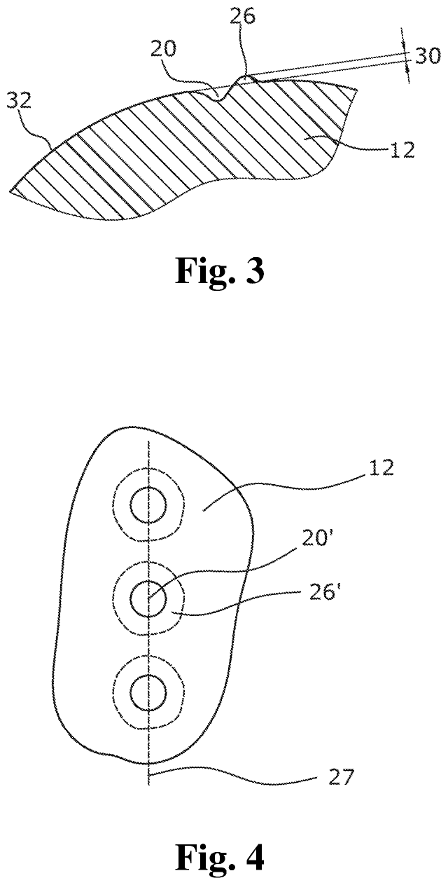

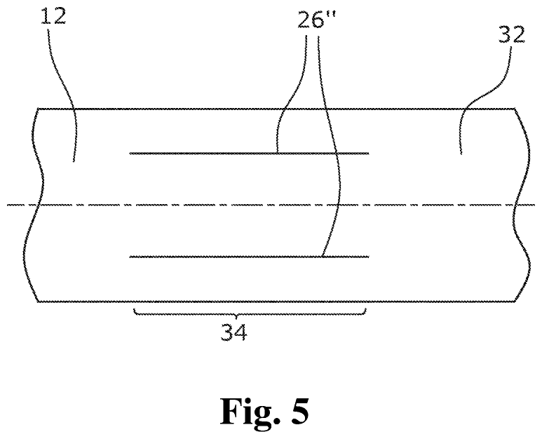

FIGS. 3 and 4 show two different embodiments of the present invention. FIG. 3 shows a continuous axial material bulging line 26″ which has been generated using a laser beam. The laser beam causes high temperatures at the hardened shaft surface 32 to thereby melt the shaft surface material and to displace the melted shaft material laterally to thereby produce substantially linear grooves 20 and the adjacent continuous axial material bulgings 26.

An alternative embodiment of the invention is shown in FIG. 4. In contrast to continuous axial material bulgings 26, the material bulgings 26′ are here ring-like and the ring-like bulgings 26′ are arranged along an axial line 27 at the shaft surface 32. The indentations 20′ surrounded by the ring-like bulgings are substantially circular.

The present invention is not limited to embodiments described herein; reference should be had to the appended claims.

### LIST OF REFERENCE NUMERALS

10 Automotive auxiliary unit
11 Motor rotor
12 Rotor shaft
14 Pump rotor
16 Electric motor
18 Motor stator
20 Linear grooves
20′ Indentations
22 Sheet metal pack
22′ Ferromagnetic metal sheets
23 Notches
24 Coil wire
24′ Rotor coil
25 Radial recesses
26 Continuous axial material bulgings
26′ Ring-like material bulgings
26″ Continuous axial material bulging line
27 Axial line (of ring-like material bulging s)
28 Permanent magnet
29 Permanent magnetic poles
30 Height (of material bulgings)
32 Shaft surface
34 Rotor fixation section

What is claimed is:

1-11. (canceled)

12. An automotive auxiliary unit with an electric motor, the automotive auxiliary unit comprising:
a motor stator;
a rotatable metallic rotor shaft which defines a rotor fixation section, the rotor fixation section comprising material bulgings at a shaft surface of the rotatable metallic rotor shaft; and
a motor rotor which is co-rotatably fixable to the rotatable metallic rotor shaft via pressing at the rotor fixation section,
wherein,
the material bulgings at the shaft surface of the rotatable metallic rotor shaft are provided via a laser engraving.

13. The automotive auxiliary unit as recited in claim 12, wherein a minimum height of the material bulgings is 15 μm.

14. The automotive auxiliary unit as recited in claim 12, wherein the motor rotor is defined by a sheet metal pack which comprises a laminated stack of ferromagnetic metal sheets.

15. The automotive auxiliary unit as recited in claim 12, wherein the shaft surface is hardened.

16. The automotive auxiliary unit as recited in claim 12, wherein the rotatable metallic rotor shaft comprises at least three of the material bulgings at the shaft surface, the at least three material bulgings being arranged so as to be continuous.

17. The automotive auxiliary unit as recited in claim 16, wherein the at least three continuous material bulgings at the shaft surface are further arranged linearly.

18. The automotive auxiliary unit as recited in claim 16, wherein the at least three material bulgings are orientated approximately axially.

19. The automotive auxiliary unit as recited in claim 12, wherein,
the material bulgings are arranged to be ring-like, and
the rotatable metallic rotor shaft comprises at least three lines of the ring-like material bulgings at the shaft surface.

20. The automotive auxiliary unit as recited in claim 19, wherein the at least three lines of ring-like material bulgings at the shaft surface are orientated substantially axially.

21. The automotive auxiliary unit as recited in claim 12, wherein the motor rotor comprises at least one coil wire.

22. The automotive auxiliary unit as recited in claim 12, wherein the motor stator comprises at least one permanent magnet.

23. The automotive auxiliary unit as recited in claim 12, wherein the automatic auxiliary unit is an automotive vacuum pump.
